(19) United States
(12) Patent Application Publication
(10) Pub. No.: US 2013/0148381 A1
(43) Pub. Date: Jun. 13, 2013

(54) DISPLAY DEVICE

(71) Applicant: Kazuya Hatta, Yonago-shi (JP)

(72) Inventor: Kazuya Hatta, Yonago-shi (JP)

(73) Assignee: SHARP KABUSHIKI KAISHA, Osaka-shi, Osaka (JP)

(21) Appl. No.: 13/818,032

(22) PCT Filed: Aug. 23, 2011
(86) PCT No.: PCT/JP2011/068923

§ 371 Date: Feb. 20, 2013

(30) Foreign Application Priority Data
Aug. 25, 2010 (JP) 2010-187922

(51) Int. Cl. F21V 8/00

(52) U.S. Cl. CPC G02B 6/0033
USPC 362/624

(57) ABSTRACT

The present invention aims to provide a display device that allows suppression of occurrence of Newton's rings while allowing reduction in number of required components. The display device of the present invention includes an optical unit including a first main surface, a peripheral surface—and a second main surface disposed to face the first main surface; a display panel and a reflective sheet including a first main plane portion covering the first main surface, a peripheral surface portion covering the peripheral surface, and a second main plane portion extending from the end portion of the peripheral surface portion and located on the second main surface. The display panel is disposed at a distance from the optical unit by sandwiching the second main plane portion between the display panel and the optical unit.

### TECHNICAL FIELD

The present invention relates to a display device.

### BACKGROUND ART

A liquid crystal display device is provided in an electronic device, for example, a mobile phone device, a digital camera, a portable game machine, a car-navigation system, a personal computer, a flat-screen television, and the like. The liquid crystal display device, which does not have a self-light emitting function, includes a liquid crystal display panel and a backlight irradiating the liquid crystal display panel with light from the back of the panel. Examples of a backlight include an edge-light type backlight having a light source disposed in an edge portion of a light guide plate, and a direct backlight having a light source disposed directly below a display screen. The edge-light type backlight is used in such a mode of causing the light incident from the edge portion of the light guide plate to be diffused by the light guide plate so as to be uniform in a display region and to be output from one of the main surfaces. Such an edge-light type backlight includes a reflective sheet stacked on one of the main surfaces of the light guide plate, a diffusion sheet stacked on the light outgoing surface that is the other side of the main surfaces, two prism sheets disposed on the diffusion sheet, and a frame.

The frame serves to form the stacked reflective sheet, light guide plate, diffusion sheet, and two prism sheets into a unit, in which a resin frame formed by injection molding is generally used in many cases. Since the thickness of the resin frame is for example about 0.3 mm, the outer size of the backlight is increased by this size of the resin frame. Furthermore, recently, there has been increasing demand for further reduction in thickness of the liquid crystal display device.

Accordingly, in recent years, various approaches for achieving a thinner backlight have been proposed. For example, the backlight disclosed in Japanese Patent Laying-Open No. 2002-311430 includes a light guide plate, a light source disposed at the end face of the light guide plate, an optical sheet disposed at the light outgoing surface of the light guide plate, and a reflective sheet.

The reflective sheet is provided so as to cover areas of the surface of the light guide plate that correspond to the main surface located on the side opposite to the light outgoing surface and facing thereto, and to other end faces on which the light source is not disposed. The reflective sheet has a hook portion formed so as to extend beyond the light outgoing main surface.

The optical sheet includes a pull-out portion engaged with this hook portion. This pull-out portion is engaged with the hook portion as described above, thereby positioning the optical sheet with respect to the backlight and fixing the optical sheet thereto.

### CITATION LIST

### Patent Literature

PTL 1: Japanese Patent Laying-Open No. 2002-311430

### SUMMARY OF INVENTION

### Technical Problem

However, when a liquid crystal display panel is mounted on the backlight disclosed in Japanese Patent Laying-Open No. 2002-311430, the liquid crystal display panel may be brought into direct contact with the light outgoing surface. When the optical sheet located on the light outgoing surface is in direct contact with the liquid crystal display panel, there may be a case where a small gap is formed between the optical sheet and the liquid crystal display panel, which may cause occurrence of Newton's rings.

In the backlight disclosed in Japanese Patent Laying-Open No. 2002-311430, it is necessary to wind an adhesive tape in order to fix the reflective sheet disposed at the end face of the light guide body.

The present invention has been made in the light of the above-described problems. An object of the present invention is to provide a display device that allows suppression of occurrence of Newton's rings while allowing reduction in number of required components.

### Solution to Problem

A display device according to the present invention includes an optical unit including a first main surface, a peripheral surface formed on a peripheral edge portion of the first main surface, and a second main surface disposed to face the first main surface and having an irradiation surface by which light is applied to outside; a display panel receiving the light from the optical unit; and a reflective sheet including a first main plane portion covering the first main surface of the optical unit, a peripheral surface portion covering the peripheral surface, and a second main plane portion extending from an end portion of the peripheral surface portion and located on the second main surface. The display panel is disposed at a distance from the optical unit by sandwiching the second main plane portion between the display panel and the optical unit.

Preferably, the optical unit includes an optical sheet and a light guide body having a placement surface on which the optical sheet is placed. The optical sheet is disposed at a position spaced apart from an outer peripheral edge portion of the placement surface. The second main plane portion is disposed on a portion of the placement surface between the outer peripheral edge portion of the placement surface and the optical sheet. The display device further includes the optical sheet and an adhesive piece bonding the optical sheet. The adhesive piece is formed so as to protrude closer to the display panel than the optical sheet, and sandwiched between the display panel and the optical unit.

Preferably, the optical unit includes an optical sheet and a light guide body having a placement surface on which the optical sheet is placed. The optical sheet is disposed at a position spaced apart from an outer peripheral edge portion of the placement surface. The second main plane portion is disposed on a portion of the placement surface between the outer peripheral edge portion of the placement surface and the optical sheet. The second main plane portion protrudes closer to the display panel than the optical sheet.

Preferably, the peripheral surface portion is provided with a protrusion protruding closer to the display panel than the optical sheet, coming into contact with a side surface of the display panel and positioning the display panel.

Preferably, the optical unit includes an optical sheet and a light guide body having a placement surface on which the optical sheet is placed. The second main plane portion is located on the optical sheet. Preferably, the second main plane portion is formed in a shape of a frame.

Preferably, the optical unit includes an optical sheet and a light guide body having a placement surface on which the optical sheet is placed. The display device further includes a light source applying light toward the light guide body. The peripheral surface portion is provided with an opening through which the light source is inserted.

### Advantageous Effects of Invention

According to the display device of the present invention, occurrence of Newton's rings can be suppressed while the number of components can be reduced.

### BRIEF DESCRIPTION OF DRAWINGS

FIG. 1 is an exploded perspective view showing a liquid crystal display device in which a backlight according to the present first embodiment is mounted.

FIG. 2 is a cross sectional view of a liquid crystal display device 1.

FIG. 3 is a perspective view of a backlight 3.

FIG. 4 is a perspective view of an optical unit 10 and a reflective sheet 11, with reflective sheet 11 developed in perspective view.

FIG. 5 is a perspective view showing the state where reflective sheet 11 is folded back from the state shown in FIG. 4.

FIG. 6 is a plan view showing the first process of a manufacturing process of backlight 3.

FIG. 7 is a plan view showing the manufacturing process after the manufacturing process shown in FIG. 6.

FIG. 8 is a plan view showing the manufacturing process after the manufacturing process shown in FIG. 7.

FIG. 9 is a plan view showing the manufacturing process after the manufacturing process shown in FIG. 8.

FIG. 10 is a plan view showing the manufacturing process after the manufacturing process shown in FIG. 9 described above.

FIG. 11 is a cross sectional view showing a modification of liquid crystal display device 1 according to the present first embodiment.

FIG. 12 is an exploded perspective view of a liquid crystal display device 1 according to the present second embodiment.

FIG. 13 is an exploded perspective view of a backlight 3 according to the present second embodiment.

FIG. 14 is a perspective view of an optical unit 10.

FIG. 15 is a developed view of a reflective sheet 11.

FIG. 16 is a cross sectional view of backlight 3 according to the present second embodiment.

FIG. 17 is a cross sectional view showing a modification of backlight 3 according to the present second embodiment.

FIG. 18 is a plan view showing the first process of the manufacturing process of backlight 3 according to the present second embodiment.

FIG. 19 is a plan view showing the second process of the manufacturing process of backlight 3.

FIG. 20 is a plan view showing the manufacturing process after the manufacturing process shown in FIG. 19.

FIG. 21 is a perspective view showing the manufacturing process after the manufacturing process shown in FIG. 20.

FIG. 22 is a plan view showing the manufacturing process after the manufacturing process shown in FIG. 21.

### DESCRIPTION OF EMBODIMENTS

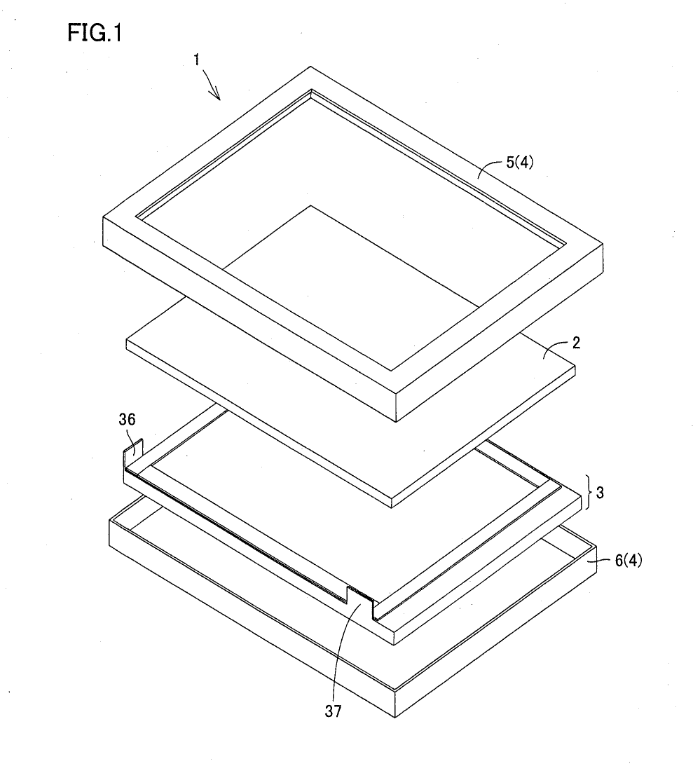

Referring to FIGS. 1 to 22, a backlight and a liquid crystal display device according to the present invention will be hereinafter described. In the embodiments described below, when the number, the quantity and the like are mentioned, the scope of the present invention is not necessarily limited thereto unless otherwise specified. In the following embodiments, each component is also not necessarily essential for the present invention unless otherwise specified. Furthermore, when a plurality of embodiments are provided in the following description, it is originally intended to combine characteristic portions in each embodiment as appropriate, unless otherwise specified.

### First Embodiment

FIG. 1 is an exploded perspective view showing a liquid crystal display device in which a backlight according to the present first embodiment is mounted.

As shown in this FIG. 1, a liquid crystal display device 1 includes a liquid crystal display panel 2, a backlight 3 applying light to liquid crystal display panel 2, and a bezel 4 forming the outline of liquid crystal display device 1. Bezel 4 includes a front bezel 5 and a back bezel 6. Front bezel 5 has a window formed so that the screen of liquid crystal display panel 2 can be observed from outside.

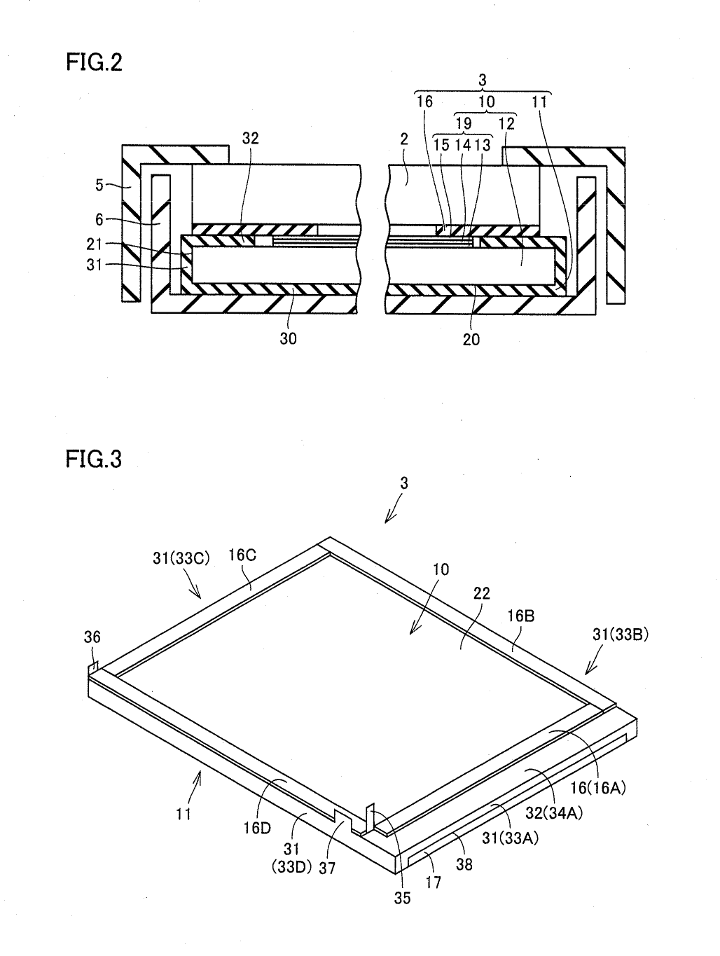

FIG. 2 is a cross sectional view of liquid crystal display device 1. As shown in this FIG. 2, backlight 3 includes an optical unit 10, a reflective sheet 11, and a light shielding sheet 16.

FIG. 3 is a perspective view of backlight 3. As shown in this FIG. 3, reflective sheet 11 is mounted in optical unit 10 so as to cover optical unit 10.

The end portion of reflective sheet 11 is bonded to optical unit 10 by light shielding sheet 16 formed in the shape of a frame. Then, a rectangular irradiation surface surrounded by light shielding sheet 16 is defined on a main surface 22 of optical unit 10.

In addition, as apparent also from this FIG. 3 and the above-described FIG. 2, light shielding sheet 16 is located closer to liquid crystal display panel 2 than main surface 22 of optical unit 10, and liquid crystal display panel 2 is disposed on light shielding sheet 16.

Consequently, contact between liquid crystal display panel 2 and optical unit 10 is suppressed, and formation of Newton's rings is suppressed.

Front bezel 5 and back bezel 6 are coupled to each other so as to sandwich liquid crystal display panel 2, light shielding sheet 16, optical unit 10, and reflective sheet 11.

As shown in FIG. 2, optical unit 10 includes a light guide plate 12 and a stacked sheet (optical sheet) 19. Reflective sheet 11 wraps light guide plate 12 and stacked sheet 19 that are placed one on top of the other, and reflective sheet 11 is fixed to optical unit 10 by light shielding sheet 16, thereby forming backlight 3.

For example, as compared with backlight 3 having a frame portion serving to position each member in the state where reflective sheet 11, light guide plate 12 and stacked sheet 19 are stacked, reflective sheet 11 also serves as a function of the above-described frame body in backlight 3 according to the present embodiment.

Accordingly, backlight 3 according to the present first embodiment allows reduction in number of components and reduction in size.

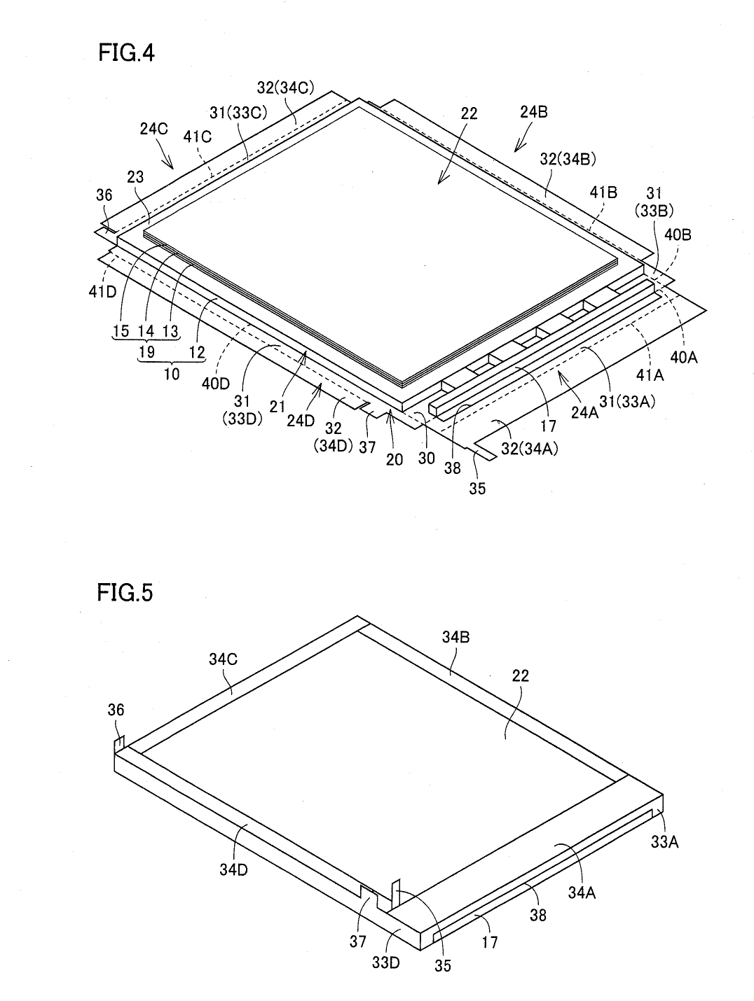

FIG. 4 is a perspective view of optical unit 10 and reflective sheet 11, with reflective sheet 11 developed in perspective view. Optical unit 10 is formed in the shape of an approximately flat plate. Optical unit 10 includes a main surface 20 formed as a lower surface, a peripheral surface 21 formed in the peripheral edge portion of this main surface 20, and a main surface 22 facing main surface 20 with peripheral surface 21 interposed therebetween.

Optical unit 10 includes a stacked sheet 19 having a diffusion sheet 13, prism sheets 14 and 15; and a light guide plate 12 having a placement surface 23 on which this stacked sheet 19 is placed. A light source unit 17 is disposed on the peripheral surface of light guide plate 12.

The light from light source unit 17 is applied to light guide plate 12. The light is repeatedly reflected within light guide plate 12, and diffused throughout within light guide plate 12. For example, a plurality of dots that are not shown are formed on main surface 20 of light guide plate 12. As light is incident upon these dots, the light is reflected toward placement surface 23. Then, the light emitted from light guide plate 12 is incident upon stacked sheet 19, and then, applied from the irradiation surface (main surface 22) toward the display panel.

As shown in FIG. 4 and the above-described FIG. 2, reflective sheet 11 includes a main plane portion 30 covering main surface 20 of optical unit 10, a peripheral surface portion 31 covering peripheral surface 21 of optical unit 10, and a main plane portion 32 located on the outer peripheral edge portion of main surface 22 of optical unit 10.

Main plane portion 32 is formed at the end side portion of peripheral surface portion 31, bent from peripheral surface portion 31, and formed so as to extend around to main surface 22.

In addition, as shown in FIG. 4, peripheral surface 21 of optical unit 10 includes a plurality of side surfaces 24A to 24D. Peripheral surface portion 31 of reflective sheet 11 is provided with side surface portions 33A to 33D for their respective side surfaces 24A to 24D.

In the example shown in FIG. 4, optical unit 10 includes four side surfaces 24A to 24D while reflective sheet 11 includes four side surface portions 33A to 33D. Main plane portion 32 includes end side portions 34A to 34D formed at the end portions of side surface portions 33A to 33D, respectively. At the end portion of side surface portion 33C, end side portion 34C and a support portion 36 are formed. At the upper end of side surface portion 33D, end side portion 34D and a support portion 37 adjacent to this end side portion 34D are formed. At the outer peripheral portion of end side portion 34A, a support portion 35 is formed.

FIG. 5 is a perspective view showing the state where reflective sheet 11 is folded back from the state shown in FIG. 4. In this FIG. 5 and FIG. 4, side surface portion 33A covers light source unit 17 and side surface 24A. Similarly, side surface portions 33B to 33D also cover side surfaces 24B to 24D, respectively.

Then, end side portions 34A to 34D are located on placement surface 23. In addition, end side portions 34A to 34D are adjacent to each other and formed so as not to overlap with each other.

As shown in FIG. 3, when end side portions 34A to 34D and optical unit 10 are bonded together by light shielding sheet 16, reflective sheet 11 is fixed to optical unit 10.

As shown in FIG. 2, light shielding sheet 16 is disposed to extend from the top of main plane portion 32 including end side portions 34A to 34D across stacked sheet 19.

Liquid crystal display panel 2 and backlight 3 sandwich light shielding sheet 16 and main plane portion 32 therebetween. Light shielding sheet 16 is located closer to liquid crystal display panel 2 than stacked sheet 19, thereby suppressing contact between liquid crystal display panel 2 and stacked sheet 19. This allows suppression of formation of Newton's rings. In this way, light shielding sheet 16 has both functions of bonding end side portions 34A to 34D and optical unit 10 together, and of providing a gap between liquid crystal display panel 2 and main surface 22 of optical unit 10, as described above.

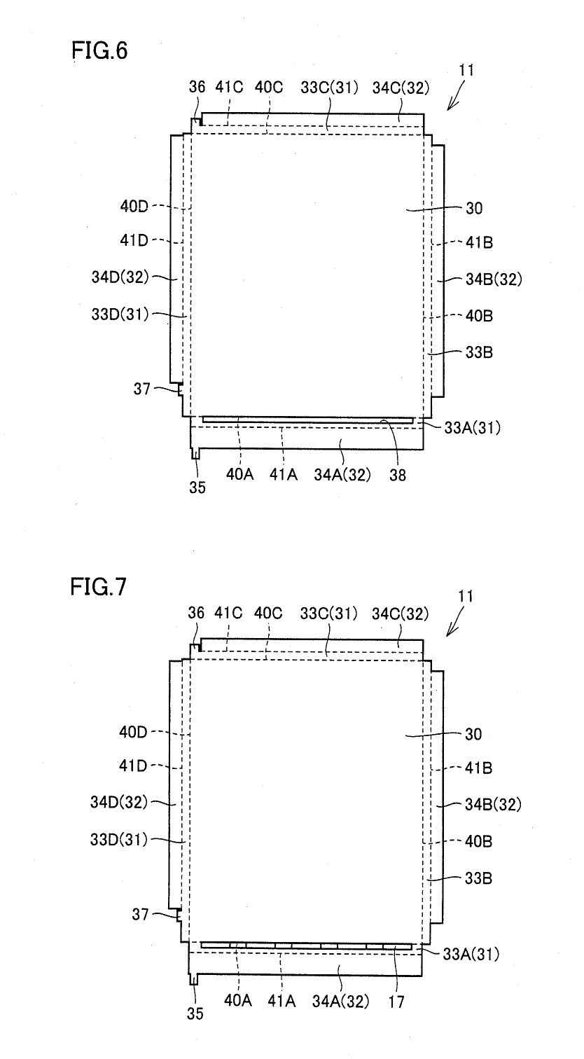

The method of manufacturing liquid crystal display device 1 configured as described above will be hereinafter described with reference to FIGS. 6 to 10.

It is to be noted that liquid crystal display device 1 can be formed generally by first producing backlight 3 and liquid crystal display panel 2 in separate processes, and then, mounting liquid crystal display panel 2 in backlight 3. Liquid crystal display panel 2 can be obtained by conducting the conventional manufacturing process. Thus, the manufacturing process of backlight 3 will be mainly described.

FIG. 6 is a plan view showing the first process of the manufacturing process of backlight 3. Reflective sheet 11 is prepared as shown in this FIG. 6. Also, as shown in this FIG. 6, folding lines 41A, 41B, 41C, and 41D are provided in their respective boundary portions between side surface portions 33A, 33B, 33C, and 33D and end side portions 34A, 34B, 34C, and 34D, respectively.

Similarly, folding lines 40A, 40B, 40C, and 40D are provided also in their respective boundary portions between main plane portion 30 and side surface portions 33A, 33B, 33C, and 33D, respectively.

In addition, folding lines 40A to 40D and folding lines 41A to 41D each are provided with a perforated groove or a line-shaped groove. In addition, folding lines 40A to 40D and folding lines 41A to 41D may be creased in advance.

FIG. 7 is a plan view showing the manufacturing process after the manufacturing process shown in FIG. 6. As shown in this FIG. 7, light source unit 17 is inserted into an opening 38 formed in side surface portion 33A. It is to be noted that light source unit 17 is not necessarily attached in this timing, but for example, may be attached after the liquid crystal display panel is attached to the backlight.

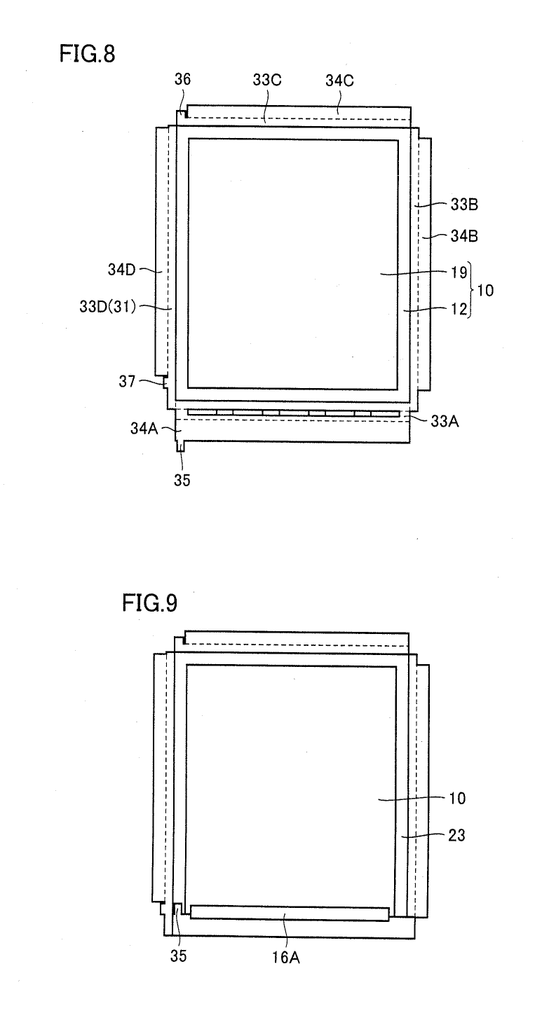

FIG. 8 is a plan view showing the manufacturing process after the manufacturing process shown in FIG. 7. As shown in this FIG. 8, optical unit 10 is disposed on main plane portion 30.

FIG. 9 is a plan view showing the manufacturing process after the manufacturing process shown in FIG. 8. As shown in this FIG. 8, side surface portion 33A is first folded back along folding line 40A. Then, end side portion 34A is folded back along folding line 41A. Consequently, end side portion 34A is disposed on placement surface 23 of optical unit 10. This end side portion 34A is first fixed by a light shielding sheet 16A.

By folding back end side portion 34A, light source unit 17 attached to end side portion 34A is moved to rest against optical unit 10, thereby causing light source unit 17 to be disposed on the side surface of light guide plate 12. Thus, end side portion 34A is folded back, thereby causing support portion 35 to be placed on placement surface 23. Then, support portion 35 is folded back to extend upright with respect to placement surface 23.

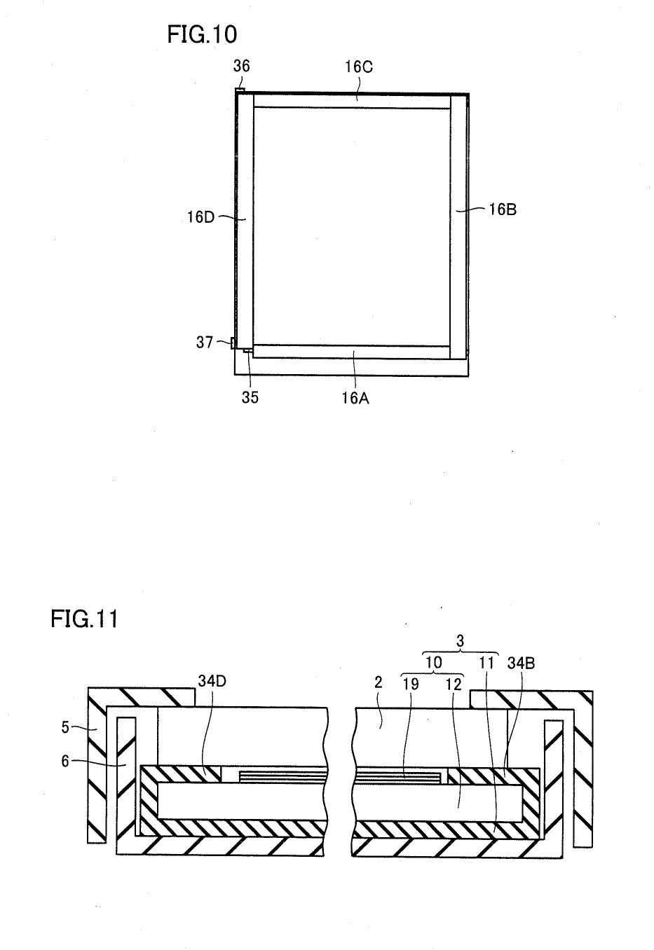

FIG. 10 is a plan view showing the manufacturing process after the manufacturing process shown in FIG. 9. As shown in FIG. 10, side surface portions 33B, 33C and 33D are also similarly bent, and further, end side portions 34B to 34D are bent. Then, end side portions 34B to 34D are bonded by light shielding sheets 16B to 16D, respectively, to main surface 22 of optical unit 10. Consequently, backlight 3 shown in FIG. 1 can be produced. In addition, when side surface portion 33D and side surface portion 33C are folded back, support portion 37 and support portion 36 protrude from the main surface of optical unit 10.

After producing backlight 3, as shown in FIG. 1, liquid crystal display panel 2 is mounted on backlight 3. Support portions 35 to 37 protrude upward from backlight 3.

Accordingly, when liquid crystal display panel 2 is mounted on backlight 3, side surfaces of liquid crystal display panel 2 are brought into contact with support portions (protrusions) 35 to 37, respectively, thereby allowing liquid crystal display panel 2 to be simply positioned.

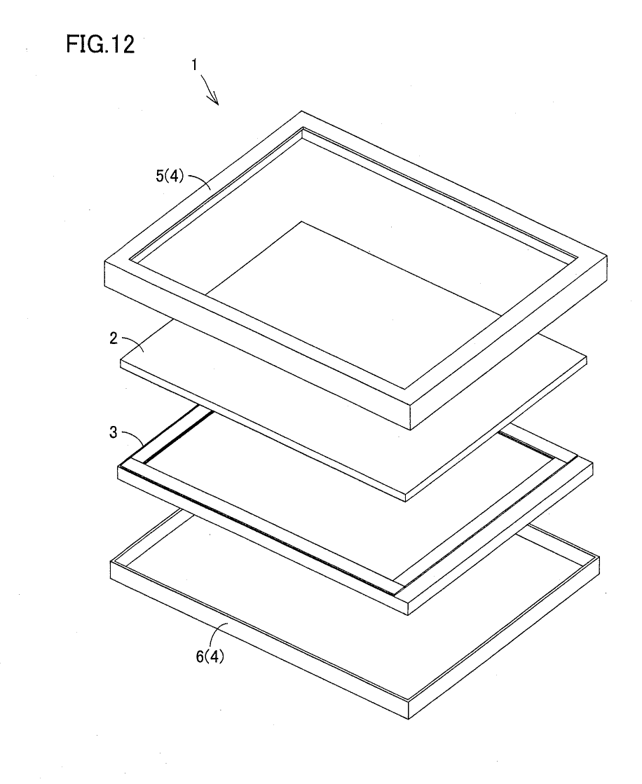

FIG. 11 is a cross sectional view showing a modification of liquid crystal display device 1 according to the present first embodiment. As shown in this FIG. 11, end side portions 34B and 34D protrude closer to liquid crystal display panel 2 than stacked sheet 19. In addition, end side portions 34A and 34C that are not shown also protrude closer to liquid crystal display panel 2 than stacked sheet 19, as with end side portions 34B and 34D.

Liquid crystal display panel 2 is disposed on end side portions 34B and 34D and also on end side portions 34A and 34C that are not shown, in which liquid crystal display panel 2 is spaced apart from stacked sheet 19.

In this way, end side portions 34A to 34D are formed greater in thickness than stacked sheet 19. End side portions 34B to 34D are fixed by being sandwiched between liquid crystal display panel 2 and light guide plate 12.

According to the example shown in this FIG. 11, light shielding sheet 16 can be omitted, which allows further reduction in number of components. Furthermore, stacked sheet 19 is not secured with a light-shielding tape. Accordingly, even if stacked sheet 19 is formed of an optical sheet having a relatively large coefficient of linear expansion, occurrence of deflection and the like can be suppressed.

### Second Embodiment

Liquid crystal display device 1 according to the present second embodiment will be hereinafter described with reference to FIGS. 12 to 22. In addition, any of the configurations shown in FIGS. 12 to 22 that are identical or correspond to those shown in FIGS. 1 to 11 described above will be designated by the same reference characters, and description thereof will not be repeated.

FIG. 12 is an exploded perspective view of liquid crystal display device 1 according to the present second embodiment. As shown in this FIG. 12, liquid crystal display device 1 according to the present second embodiment also includes backlight 3, liquid crystal display panel 2 disposed on backlight 3, and front bezel 5 and back bezel 6 sandwiching liquid crystal display panel 2 and backlight 3 therebetween.

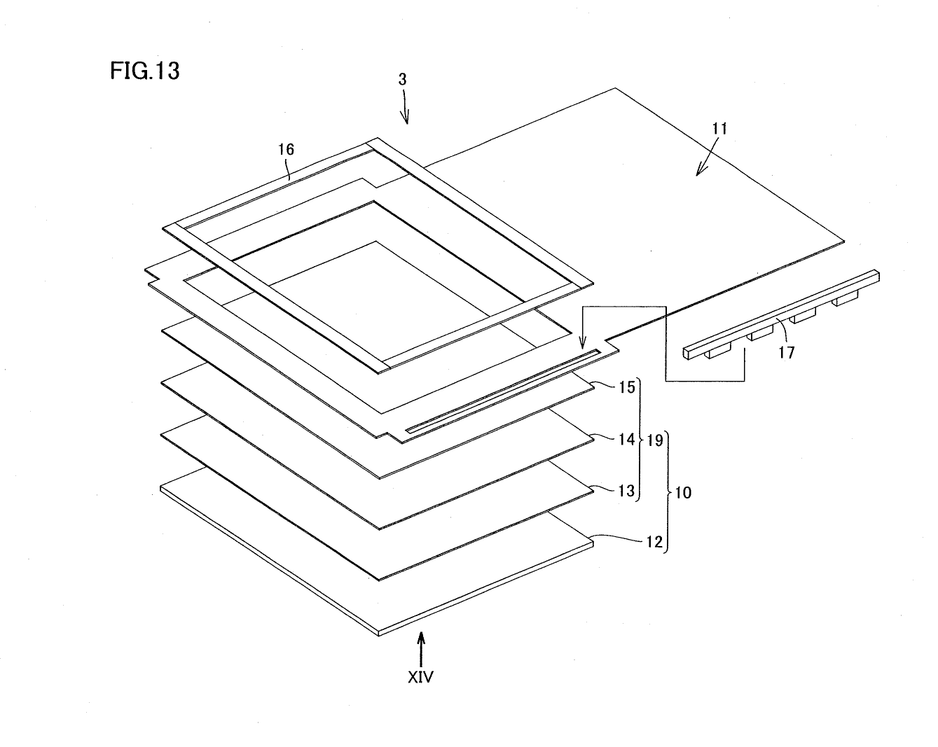

FIG. 13 is an exploded perspective view of backlight 3 according to the present second embodiment. As shown in this FIG. 13, backlight 3 includes reflective sheet 11, optical unit 10, light shielding sheet 16 bonding reflective sheet 11 and optical unit 10 together, and light source unit 17 disposed on the side surface of light guide plate 12.

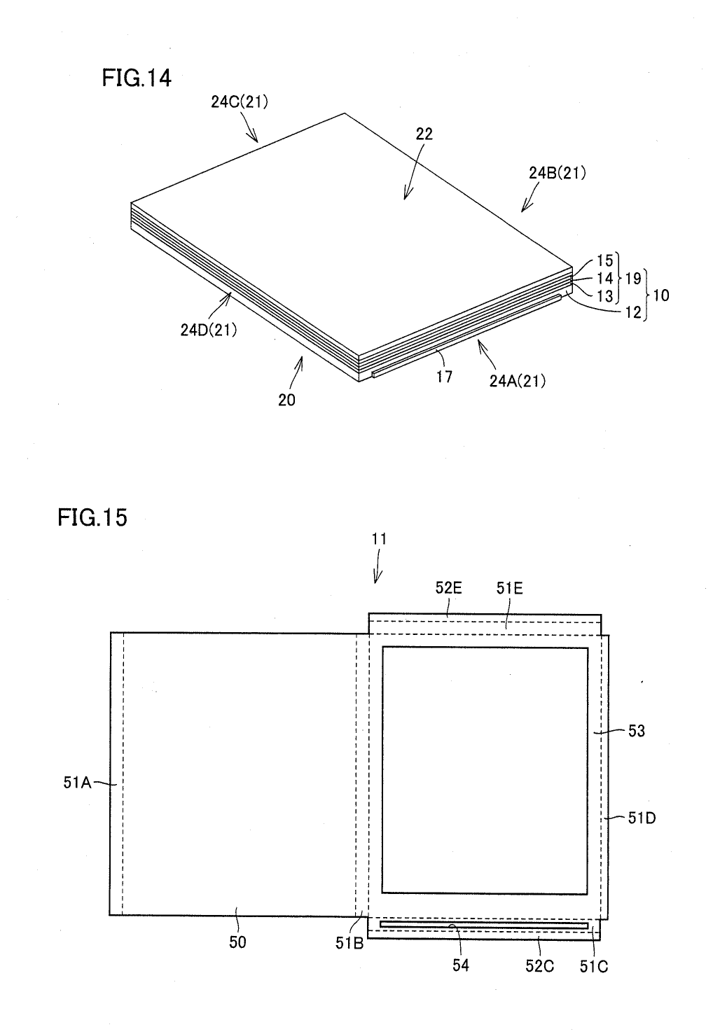

FIG. 14 is a perspective view of optical unit 10. As shown in this FIG. 14, optical unit 10 includes light guide plate 12 and stacked sheet 19 disposed on light guide plate 12. Stacked sheet 19 includes diffusion sheet 13 and prism sheets 14 and 15. It is to be noted that light source unit 17 is disposed on the side surface of light guide plate 12 on the side surface 24A side.

FIG. 15 is a developed view of reflective sheet 11. Reflective sheet 11 includes a main plane portion 50 covering main surface 20 of optical unit 10 shown in FIG. 14, a side surface portion 51B formed on one side of main plane portion 50, and a main plane portion 53 formed on one side of side surface portion 51B.

A side surface portion 51A is formed in a side portion of the peripheral edge portion of main plane portion 50 that is located opposite to the side portion on which side surface portion 51B is formed.

Main plane portion 53 is formed in the shape of a frame and has a peripheral edge portion at which a side surface portion 51C, a side surface portion 51D and a side surface portion 51E are formed.

Side surface portion 51D is located across main plane portion 53 from side surface portion 51B while an end portion 52C is located across main plane portion 53 from side surface portion 51E.

Side surface portion 51C is provided with opening 54 through which light source unit 17 shown in FIG. 13 is inserted. End portion 52C is formed in a portion of the peripheral edge portion of side surface portion 51C that is located on the side opposite to main plane portion 53. An end portion 52E is formed in a side portion of the peripheral edge portion of side surface portion 51E that is located opposite to the side portion connecting to main plane portion 53.

As shown in FIG. 13, main plane portion 53 formed in the shape of a frame is disposed on the upper surface of prism sheet 15 and fixed by light shielding sheet 16. It is to be noted that this light shielding sheet 16 is not an indispensable component.

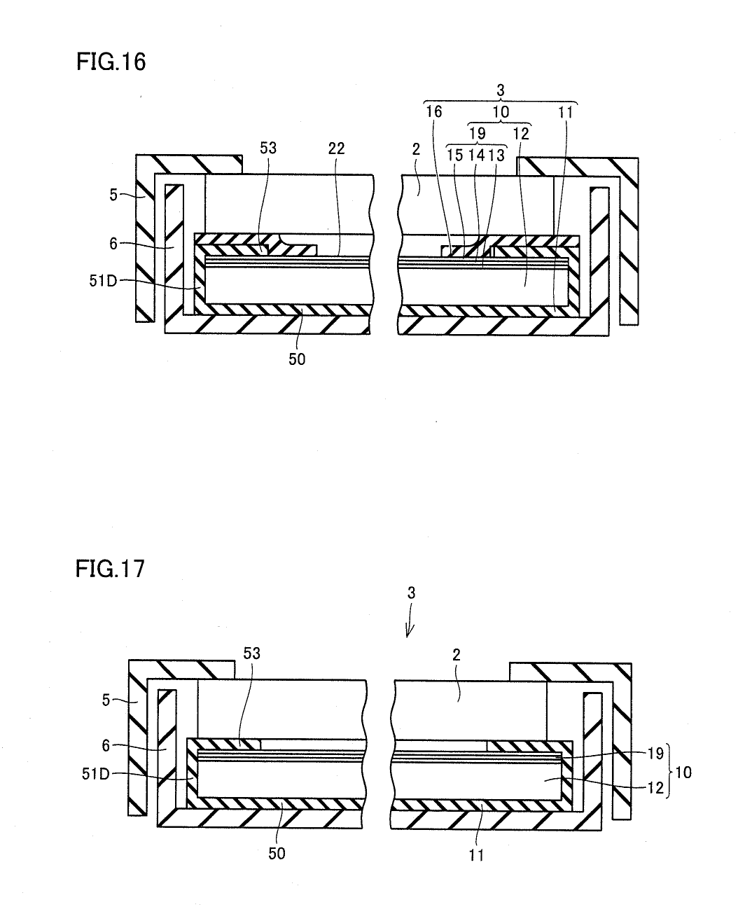

Then, as shown in FIG. 12, liquid crystal display panel 2 is disposed on light shielding sheet 16. FIG. 16 is a cross sectional view of backlight 3 according to the present second embodiment. As shown in this FIG. 16, main plane portion 53 and light shielding sheet 16 are sandwiched between liquid crystal display panel 2 and optical unit 10, and a gap is formed between optical unit 10 and liquid crystal display panel 2.

Thus, also in backlight 3 according to the present second embodiment, main plane portion 53 that is a part of reflective sheet 11 extends around to main surface 22, and this main plane portion 53 and light shielding sheet 16 fixing this main plane portion 53 are sandwiched between liquid crystal display panel 2 and optical unit 10, thereby providing a gap between liquid crystal display panel 2 and optical unit 10.

Furthermore, also in the present second embodiment, reflective sheet 11 fixes optical unit 10, thereby allowing reduction in number of components.

FIG. 17 is a cross sectional view showing a modification of backlight 3 according to the present second embodiment. In the example shown in this FIG. 17, while light shielding sheet 16 is not provided, main plane portion 53 of reflective sheet 11 is sandwiched between liquid crystal display panel 2 and optical unit 10, to thereby fix main plane portion 53.

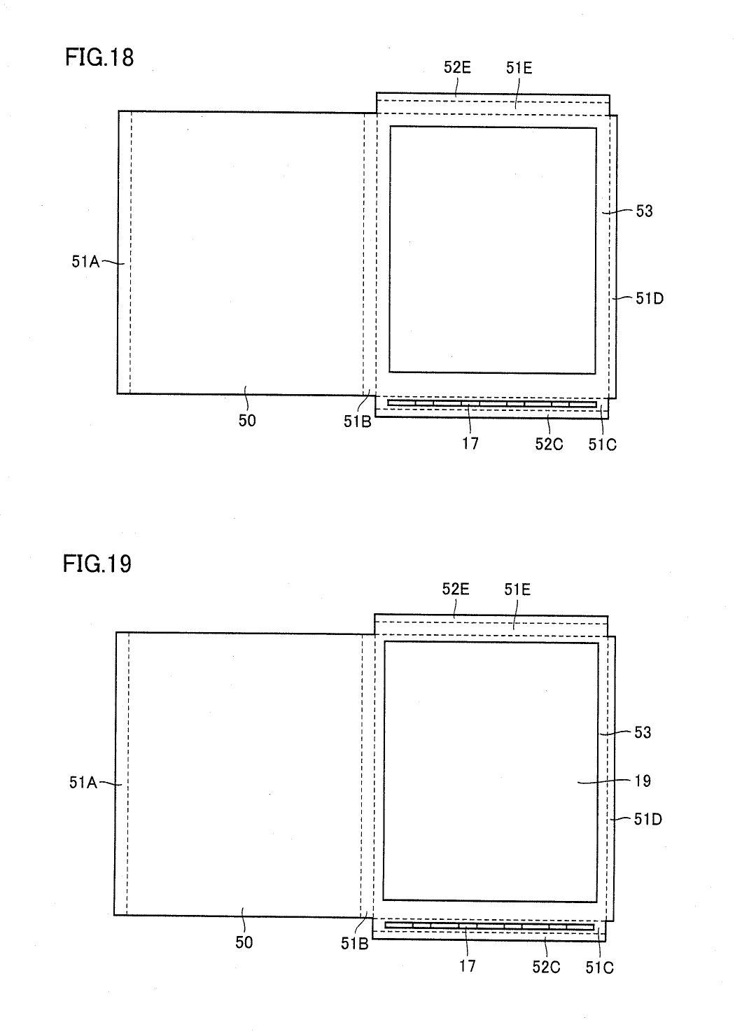

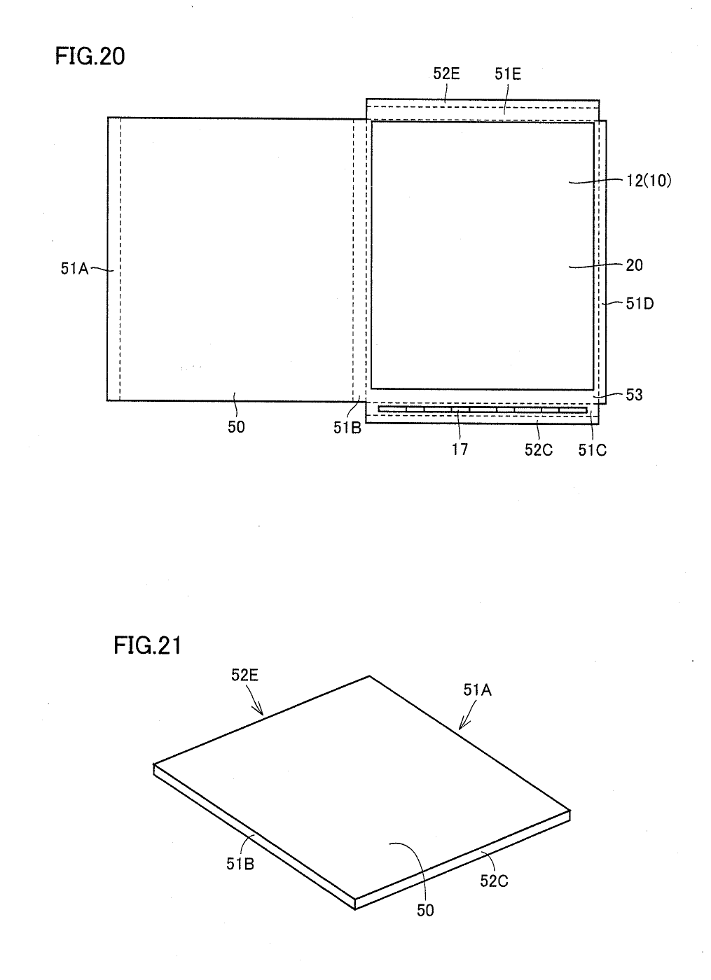

The method of manufacturing liquid crystal display device 1 configured as described above will be hereinafter described. FIG. 18 is a plan view showing the first process of the manufacturing process of backlight 3 according to the present second embodiment. As shown in this FIG. 18, light source unit 17 is attached to opening 54 shown in FIG. 15. FIG. 19 is a plan view showing the second process of the manufacturing process of backlight 3. As shown in this FIG. 19, stacked sheet 19 is disposed on main plane portion 53. Specifically, prism sheet 15, prism sheet 14 and diffusion sheet 13 are sequentially stacked. Then, light guide plate 12 is disposed on stacked sheet 19 as shown in FIG. 20.

Then, side surface portion 51C and end portion 52C are bent. By bending side surface portion 51C, light source unit 17 provided in side surface portion 51C is moved to rest against light guide plate 12, and then, light source unit 17 is disposed on the side surface of light guide plate 12.

Similarly, side surface portion 51E is bent to cover the side surface of optical unit 10. Then, by bending end portion 52E, end portion 52E is located on main surface 20 of optical unit 10. Furthermore, side surface portion 51D is bent, and side surface portion 51B is bent. Then, main plane portion 50 is bent and side surface portion 51A is bent.

Consequently, main plane portion 50 is located on end portion 52E and end portion 52C while side surface portion 51A is located on the outside of side surface portion 51D.

Then, as shown in FIG. 21, side surface portion 51B, side surface portion 51C, side surface portion 51D, and side surface portion 51E are fixed with an adhesive tape.

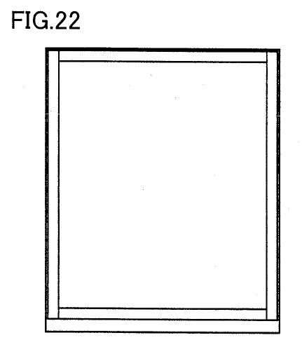

Then, as shown in FIG. 22, main plane portion 53 and optical unit 10 are bonded together by light shielding sheet 16. This leads to formation of backlight 3.

In this way, after forming backlight 3, liquid crystal display panel 2 is disposed on the upper surface of this backlight 3. Then, backlight 3 and liquid crystal display panel 2 are sandwiched by front bezel 5 and back bezel 6, to form liquid crystal display device 1. According to backlight 3 of the present embodiment, since stacked sheet 19 is not secured with a light-shielding tape, even if stacked sheet 19 is formed of an optical sheet having a relatively large coefficient of linear expansion, occurrence of deflection and the like can be suppressed.

Although the explanation has been given in the above-described first and second embodiments with regard to the example in which the present invention is applied to an edge-light type backlight, the present invention can also be applied to a direct backlight not having an optical sheet and the like. Although the embodiments of the present invention have been described as above, it should be understood that the embodiments disclosed herein are illustrative and non-restrictive in every respect. The scope of the present invention is defined by the terms of the claims, and is intended to include any modifications within the scope and meaning equivalent to the terms of the claims. Furthermore, the above-described numerical values are merely by way of example and not limited to the above-described numerical values and the ranges.

### INDUSTRIAL APPLICABILITY

The present invention is applicable to a display device.

### REFERENCE SIGNS LIST

1 liquid crystal display device, 2 liquid crystal display panel, 3 backlight, 4 bezel, 5 front bezel, 6 back bezel, 10 optical unit, 11 reflective sheet, 12 light guide plate, 13 diffusion sheet, 14, 15 prism sheet, 16A, 16B to 16D light shielding sheet, 17 light source unit, 19 stacked sheet, 20, 22 main surface, 21 peripheral surface, 23 placement surface, 24A to 24D, 24A, 24B to 24D side surface, 30, 32, 50, 53 main plane portion, 31 peripheral surface portion, 33A to 33D side surface portion, 34A to 34D end side portion, 35 to 37 support portion, 38, 54 opening, 40A to 40D folding line.

1. A display device comprising:
an optical unit including a first main surface, a peripheral surface formed on a peripheral edge portion of said first main surface, and a second main surface disposed to face said first main surface and having an irradiation surface by which light is applied to outside;
a display panel receiving light from said optical unit; and
a reflective sheet including a first main plane portion covering said first main surface of said optical unit, a peripheral surface portion covering said peripheral surface, and a second main plane portion extending from an end portion of said peripheral surface portion and located on said second main surface,
said display panel being disposed at a distance from said optical unit by sandwiching said second main plane portion between said display panel and said optical unit.

2. The display device according to claim 1, wherein
said optical unit includes an optical sheet and a light guide body having a placement surface on which said optical sheet is placed,
said optical sheet is disposed at a position spaced apart from an outer peripheral edge portion of said placement surface,
said second main plane portion is disposed on a portion of said placement surface between the outer peripheral edge portion of said placement surface and said optical sheet,
said display device further comprises said optical sheet and an adhesive piece bonding said optical sheet, and
said adhesive piece is formed so as to protrude closer to said display panel than said optical sheet, and sandwiched between said display panel and said optical unit.

3. The display device according to claim 2, wherein
said optical unit includes an optical sheet and a light guide body having a placement surface on which said optical sheet is placed,
said optical sheet is disposed at a position spaced apart from an outer peripheral edge portion of said placement surface,
said second main plane portion is disposed on a portion of said placement surface between the outer peripheral edge portion of said placement surface and said optical sheet, and
said second main plane portion protrudes closer to said display panel than said optical sheet.

4. The display device according to claim 3, wherein said peripheral surface portion is provided with a protrusion protruding closer to said display panel than said optical sheet, coming into contact with a side surface of said display panel and positioning said display panel.

5. (canceled)

6. (canceled)

7. The display device according to claim 4, wherein
said optical unit includes an optical sheet and a light guide body having a placement surface on which said optical sheet is placed,
said display device further comprises a light source applying light toward said light guide body, and
said peripheral surface portion is provided with an opening through which the light source is inserted.

8. The display device according to claim 3, wherein
said display device further comprises a light source applying light toward said light guide body, and
said peripheral surface portion is provided with an opening through which the light source is inserted.

9. The display device according to claim 2, wherein said peripheral surface portion is provided with a protrusion protruding closer to said display panel than said optical sheet, coming into contact with a side surface of said display panel and positioning said display panel.

10. The display device according to claim 9, wherein
said display device further comprises a light source applying light toward said light guide body, and
said peripheral surface portion is provided with an opening through which the light source is inserted.

11. The display device according to claim 2, wherein
said display device further comprises a light source applying light toward said light guide body, and
said peripheral surface portion is provided with an opening through which the light source is inserted.

12. The display device according to claim 1, wherein
said optical unit includes an optical sheet and a light guide body having a placement surface on which said optical sheet is placed,
said optical sheet is disposed at a position spaced apart from an outer peripheral edge portion of said placement surface,
said second main plane portion is disposed on a portion of said placement surface between the outer peripheral edge portion of said placement surface and said optical sheet, and
said second main plane portion protrudes closer to said display panel than said optical sheet.

13. The display device according to claim 12, wherein said peripheral surface portion is provided with a protrusion protruding closer to said display panel than said optical sheet, coming into contact with a side surface of said display panel and positioning said display panel.

14. The display device according to claim 13, wherein
said display device further comprises a light source applying light toward said light guide body, and
said peripheral surface portion is provided with an opening through which the light source is inserted.

15. The display device according to claim 12, wherein
said display device further comprises a light source applying light toward said light guide body, and
said peripheral surface portion is provided with an opening through which the light source is inserted.

16. The display device according to claim 1, wherein
said optical unit includes an optical sheet and a light guide body having a placement surface on which said optical sheet is placed, and
said second main plane portion is located on said optical sheet.

17. The display device according to claim 16, wherein said second main plane portion is formed in a shape of a frame.

18. The display device according to claim 17, wherein
said display device further comprises a light source applying light toward said light guide body, and
said peripheral surface portion is provided with an opening through which the light source is inserted.

19. The display device according to claim 16, wherein
said display device further comprises a light source applying light toward said light guide body, and
said peripheral surface portion is provided with an opening through which the light source is inserted.

20. The display device according to claim 1, wherein
said optical unit includes an optical sheet and a light guide body having a placement surface on which said optical sheet is placed,
said display device further comprises a light source applying light toward said light guide body, and
said peripheral surface portion is provided with an opening through which the light source is inserted.
